(19) United States
(12) Patent Application Publication
(10) Pub. No.: US 2014/0204698 A1
(43) Pub. Date: Jul. 24, 2014

(54) BLENDER BLADE OR MIXER BLADE GUARD DEVICE

(71) Applicant: Manitowoc Foodservice Companies, LLC, Manitowoc, WI (US)

(72) Inventors: Derek Morrison, Chicago, IL (US); Paul Hanniffy, Louisville, KY (US); Bill Teller, Sellersburg, IN (US); Gregory Alan Meyer, Charlestown, IN (US)

(73) Assignee: Manitowoc Foodservice Companies, LLC, Manitowoc, WI (US)

(21) Appl. No.: 13/748,335

(22) Filed: Jan. 23, 2013

(51) Int. Cl. B01F 15/00

(52) U.S. Cl. CPC B01F 15/00967
USPC 366/343

(57) ABSTRACT

A blender blade or mixer blade guard device includes a guard housing having a top portion and a sidewall and a plurality of openings disposed in the guard housing. Each of the opening is located on the guard housing proximal to either the top portion, an interface between the top portion and the sidewall, the sidewall or any combinations thereof.

### BACKGROUND

1. Field

The present disclosure generally relates to methods and apparatuses for blending or mixing with a blending or mixing blade. In particular, the present disclosure relates to a blender blade or mixer blade guard device that directs flow of ingredients that are blended or mixed by the blending or mixing blade.

2. Discussion of the Background Art

One conventional assembly that dispenses and mixes beverages and uses a blender blade or mixer blade guard device is shown in FIG. 1, and is referred to by reference numeral 100. Assembly 100 is shown and described in U.S. patent application Ser. No. 12/633,790, filed Dec. 8, 2009, that is hereby incorporated by reference.

Assembly 100 makes ice, dispenses flavors/ingredients and ice into a serving cup 15, and then blends or mixes to form a beverage. One such beverage, for example, is a smoothie that preferably includes a flavor ingredient and ice mixed together. As shown in FIG. 2, assembly 100 has an onboard ice maker, ice storage and portion control module 300, a flavor/ingredient dispensing module 1100, and a blender/mixer/cleaning module 303. Assembly 100 shows ice maker, ice storage and portion control module 300, flavor/ingredient dispensing module 1100, and blender/mixer/cleaning module 303 as one integrated assembly.

Referring back to FIG. 1, assembly 100 has a housing that includes a lower wall 6, an upper wall 7, side walls 11 and 12, and a top wall 13. Cup holders 14 removably hold cups 15 therein. Cup 15 may be disposable or reusable single serving cups. If cup 15 is disposable, such as, for example, paper or plastic cups, the beverage dispensed and mixed within cup 15 may be served directly to a customer eliminating the step of pouring the beverage into a serving cup and eliminating labor needed to wash an additional container. Cup 15 may be any size, such as, for example, about 10 ounces to about 32 ounces.

Referring to FIG. 2, upper wall 7 has been removed from assembly 100 for illustration purposes. Assembly 100 has two blender/mixer/cleaning modules 303.

Referring to FIG. 3, blender/mixer/cleaning modules 303 each has a mixer housing 205 and an interior volume 230. Interior volume 230 may be enclosed by a door 235 that moves to a closed position when in blending, mixing or cleaning mode and an open position uncovering interior volume 230 when blender/mixer/cleaning module 303 is in a load or unload mode. Bottom wall 225 may have a drain aperture 227.

Mixer housing 205 is optionally supported on a support structure 237. Support structure 237 has a motor support 239 that extends therefrom. Motor support 239 is connected to a motor 240. Motor 240 may be a stepper motor 241a with a linear slide 241 that is connected to motor support 239. Motor 240 is connected to a mixer 245. Motor 240 may be connected to mixer 245 by a bracket 247 that is moved by motor 240. Motor 240 moves spindle shaft 260 of mixer 245 in a reciprocal vertical movement through top wall 220 into or out of interior volume 230.

Mixer 245 has a spindle assembly 242 having a blender blade 255 that is wider than a spindle shaft 260. Blender blade 255 has projections that facilitate mixing of liquid within the cup 15. Spindle shaft 260 connects to a mixer motor 265 that spins blender blade 255 and spindle shaft 260.

Mixer 245 may be attached to linear slide 241 so that linear slide 241 moves mixer 245 vertically. A controller provides a mixing profile that ensures proper mixing of the beverage. Linear slide 241 is driven by the stepper motor 241a that provides precise control of movement of linear slide 241. Controller may move blender blade 255 about 25% into the liquid within cup 15 before mixer 245 is energized to spin blender blade 255. By moving blender blade 255 about 25% into the liquid within cup 15 before mixer 245 is energized to spin blender blade 255, splatter from mixer 245 energizing before entering into the beverage is reduced and/or eliminated. After blender blade 255 is energized a customizable program indexes blender blade 255 down into cup 15. Blender blade 255 may be energized with a customizable program that indexes blender blade 255 down into cup 15 to ensure that ice, for example, nugget ice, has a particle size that is reduced to beverage specifications defined by the user. Blender blade 255 dwells at a bottom of cup 215 for a predetermined amount of time. Blender blade 255 is raised and lowered for a predetermined period of time to provide complete blending of components of the beverage. After mixing is complete spindle assembly 242 returns to a home position. Stepper motor 240a and linear slide 240 may have a controller that counts a number of steps that motor travels allowing precise location of blender blade 255 leading to uniform beverages each time a beverage is dispensed and mixed from assembly 100. Preferably, blender blade 255 is an emulsifying blade.

Blender blade 255 is surrounded by a blender blade or mixer blade guard device 289. Blender blade 255 rotates inside of blender blade or mixer blade guard device 289 when mixer 245 is energized.

Referring to FIG. 4, spindle shaft 260 is positioned in a spindle shaft housing 292 so that spindle shaft 260 rotates inside of spindle shaft housing 292. Blender blade or mixer blade guard device 289 has a top wall 294 connected to spindle shaft housing 292. Blender blade or mixer blade guard device 289 has a sidewall 296 that extends from top wall 294. Sidewall 296 has gaps 297 formed by two sidewall protrusions 298 on opposite sides of each of gaps 297.

Referring to FIGS. 5-7, blender blade 255 has a connector portion 255a that connects to spindle shaft 260 and three blade portions 255b, 255c and 255d. Three blade portions 255b, 255c and 255d have blade portion 255b that is bent toward spindle shaft 260, blade portion 255c bent away from spindle shaft 260 and blade portion 255d that is straight or unbent. Blender blade 255 is positioned inside of blender blade or mixer blade guard device 289 so that sidewall protrusions 298 extend beyond blender blade 255.

During mixing and blending, gaps 297 and sidewall protrusions 298 of blender blade or mixer blade guard device 289 allow high velocity particles to impact side walls of cup 15. These high velocities project a slurry mix containing liquids and undissolved ice shards against inner sides of cup 15 whose material may be thin and brittle and susceptible to occasional cracking with the added stresses of impact and pressure from the liquid and solid slurry mix.

FIG. 8 shows a diagram illustrating a top view of a primary flow 700, illustrated by arrows, of a fluid or a solid and fluid mixture in cup 15 being mixed by blade 255 positioned in blender blade or mixer blade guard device 289. Primary flow 700 is in a continuous circular flow inward toward a center of cup 15.

FIG. 9 is a diagram illustrating a top side perspective view of secondary flows, illustrated by arrows, of the fluid or the solid and fluid mixture in cup 15 being mixed by blade 255 positioned in blender blade or mixer blade guard device 289. As shown in a circle 805, secondary flows of the fluid or the solid and fluid mixture impact the side of cup 15.

Accordingly, there is a need for a blender blade or mixer blade guard device that reduces outward pressure and reduces a velocity of fluid and solid particles being blended or mixed that normally collide with the interior walls of cup 15.

The present disclosure also provides many additional advantages, which shall become apparent as described below.

### SUMMARY

A blender blade or mixer blade guard device is provided that includes a guard housing having a top portion and a sidewall and a plurality of openings disposed in the guard housing. Each of the opening is located on the guard housing proximal to either the top portion, an interface between the top portion and the sidewall, the sidewall or any combinations thereof.

Further objects, features and advantages of the present disclosure will be understood by reference to the following drawings, detailed description and appended claims.

### BRIEF DESCRIPTION OF THE DRAWINGS

FIG. 1 is a front perspective view of an exemplary embodiment of a system that dispenses and mixes beverages according to the prior art;

FIG. 2 is a partial front cross-sectional view of the integrated ice maker bin and portion control assembly, dispensing nozzle and pair of oppositely disposed mixer/cleaning modules according to the prior art;

FIG. 3 is a right side view of the blender/mixer/cleaning module of FIG. 2 with a serving cup disposed therein, the blending blade in the retracted position and the door in the closed position according to the prior art;

FIG. 4 is a top side perspective view of a spindle assembly connected to a motor having a blender blade or mixer blade guard device of the prior art.

FIG. 5 is a bottom side perspective view of the spindle assembly connected to the motor having the blender blade or mixer blade guard device of FIG. 4.

FIG. 6 is an enlarged partial bottom side perspective view of the spindle assembly having the blender blade or mixer blade guard device of FIG. 4.

FIG. 7 is an enlarged partial side cross-sectional view of the spindle assembly having the blender blade or mixer blade guard device of FIG. 4.

FIG. 8 is a diagram illustrating a top view of a primary flow of fluid or a solid and fluid mixture in a cup being mixed by the spindle assembly connected to the motor having the blender blade or mixer blade guard device of FIG. 4.

FIG. 9 is a diagram illustrating a top side perspective view of secondary flows of the fluid or the solid and fluid mixture in the cup being mixed by the spindle assembly connected to the motor having the blender blade or mixer blade guard device of FIG. 4.

FIG. 10 is a top side perspective view of a blender blade or mixer blade guard device according to the present disclosure.

FIG. 11 is a bottom side perspective view of the blender blade or mixer blade guard device of FIG. 10.

FIG. 12 is a top view of the blender blade or mixer blade guard device of FIG. 10.

FIG. 13 is a side view of the blender blade or mixer blade guard device of FIG. 10.

FIG. 14 is a bottom view of the blender blade or mixer blade guard device of FIG. 10.

FIG. 15 is a top side perspective view of the blender blade or mixer blade guard device of FIG. 10.

FIG. 16 is a bottom side perspective view of the blender blade or mixer blade guard device of FIG. 10.

FIG. 17 is a top side perspective view of a spindle assembly connected to a motor having the blender blade or mixer blade guard device of FIG. 10.

FIG. 18 is a partial top side perspective view of the spindle assembly having the blender blade or mixer blade guard device of FIG. 10.

FIG. 19 is a bottom side perspective view of the spindle assembly connected to the motor having the blender blade or mixer blade guard device of FIG. 10.

FIG. 20 is a bottom side perspective view of the spindle assembly having the blender blade or mixer blade guard device of FIG. 10 with a portion cut away.

FIG. 21 is an enlarged partial bottom side perspective view of the spindle assembly having the blender blade or mixer blade guard device of FIG. 10.

FIG. 22 is an enlarged partial side cross-sectional view of the spindle assembly having the blender blade or mixer blade guard device of FIG. 10.

FIG. 23 is a partial side view of the spindle assembly having the blender blade or mixer blade guard device of FIG. 10 having the spindle assembly and the blender blade or mixer blade guard device that are transparent.

FIG. 24 is an enlarged partial top cross-sectional view of the spindle assembly having the blender blade or mixer blade guard device of FIG. 10.

FIG. 25 is a bottom view of the spindle assembly having the blender blade or mixer blade guard device of FIG. 10.

FIG. 26 is a diagram illustrating a top view of a primary flow of a fluid or a solid and fluid mixture in a cup being mixed by the spindle assembly connected to the motor having the blender blade or mixer blade guard device of FIG. 10.

FIG. 27 is a diagram illustrating a top side perspective view of secondary flows of the fluid or the solid and fluid mixture in the cup being mixed by the spindle assembly connected to the motor having the blender blade or mixer blade guard device of FIG. 10.

FIG. 28 is a diagram of a side view of the blender blade or mixer blade guard device of FIG. 10 illustrating flow of the fluid or the solid and fluid mixture being mixed by the blade in the blender blade or mixer blade guard device.

FIG. 29 is a top view of another embodiment of a blender blade or mixer blade guard device according to the present disclosure.

FIG. 30 is a side view of the blender blade or mixer blade guard device of FIG. 29.

FIG. 31 is a bottom view of the blender blade or mixer blade guard device of FIG. 29.

FIG. 32 is a top side perspective view of the blender blade or mixer blade guard device of FIG. 29.

FIG. 33 is a bottom side perspective view of the blender blade or mixer blade guard device of FIG. 29.

### DETAILED DESCRIPTION OF THE PREFERRED EMBODIMENT

Referring to the drawings and in particular to FIG. 10, an exemplary embodiment of a blender blade or mixer blade guard device according to the present disclosure is shown and is generally referred to by reference numeral 600 (“guard device 600”). Guard device 600 has a guard wall 605 with an exterior surface 606. Guard wall 605 has a top wall 610 and a sidewall 615 connected to top wall 610. Sidewall 615 is connected to top wall 610 at an intersection 620. Intersection 620 may be a bend in guard wall 605. Sidewall 615 extends away from top wall 610, for example, forming an angle of 65.55 degrees. Openings 625 are through guard wall 605. Openings 625 are at a position through intersection 620, top wall 610 and sidewall 615. Top wall 610 has a connection aperture 630. Variable shaped orifices are possible for openings 625, and elongated ovals/kidney bean shapes are depicted. Preferably, openings 625 do not have sharp edges. Top wall 610 is connected to a connection wall 635 that surrounds connection aperture 630.

Referring to FIG. 11, guard wall 605 has an interior surface 607. Guard wall 605 increases in thickness from a position on top wall 610 to connection aperture 630 forming a curved portion 640 of interior surface 607.

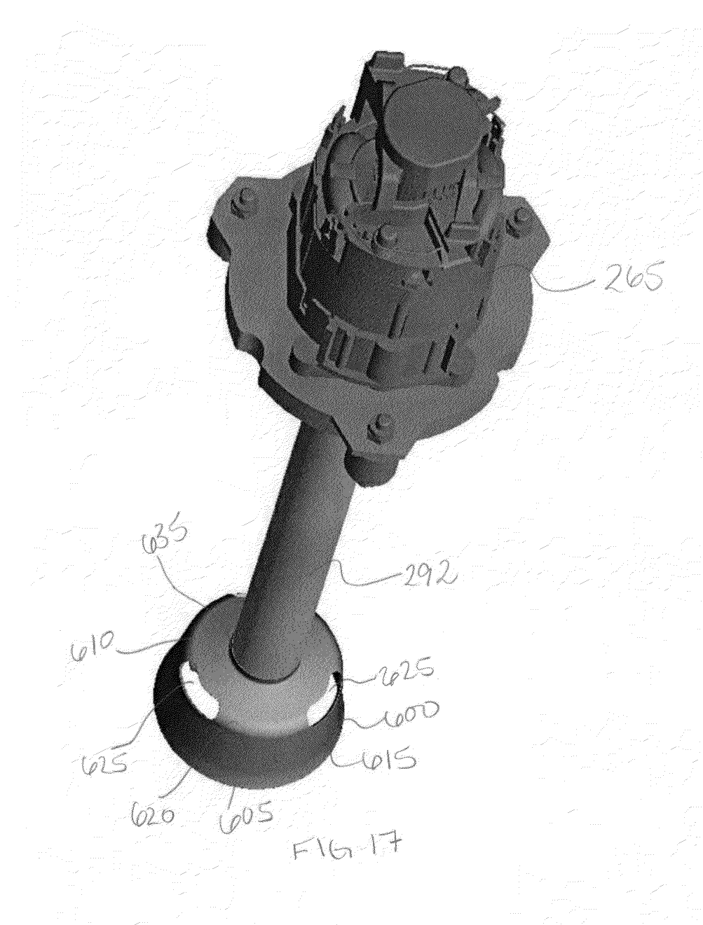

Referring to FIGS. 12-16, sidewall 615 increases in size from top wall 610 to an end 645 of sidewall 615. End 645 surrounds a bottom opening 646 of guard 600. Sidewall 615 increases in size at a first rate from top wall 610 to a first distance D1 and sidewall 615 increases in size at a second rate from first distance D1 to end 645. Second rate is greater than the first rate forming a flared portion 647 from first distance D1 to end 645.

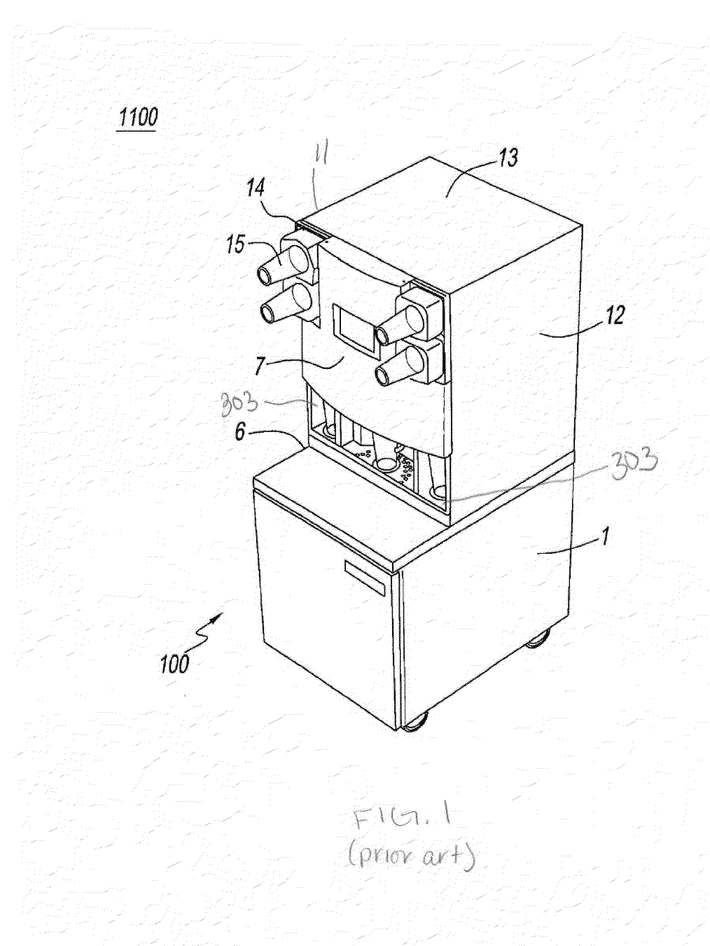

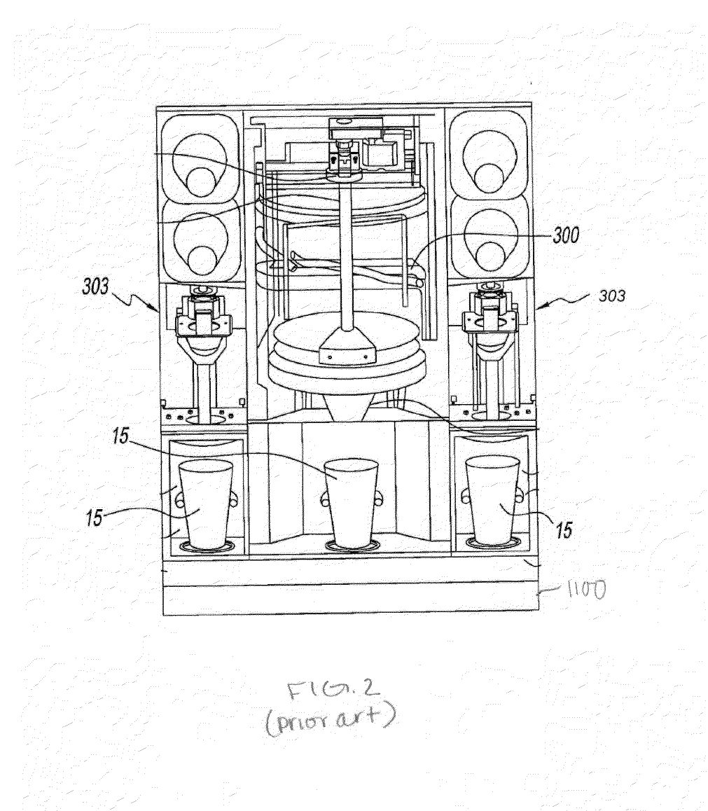

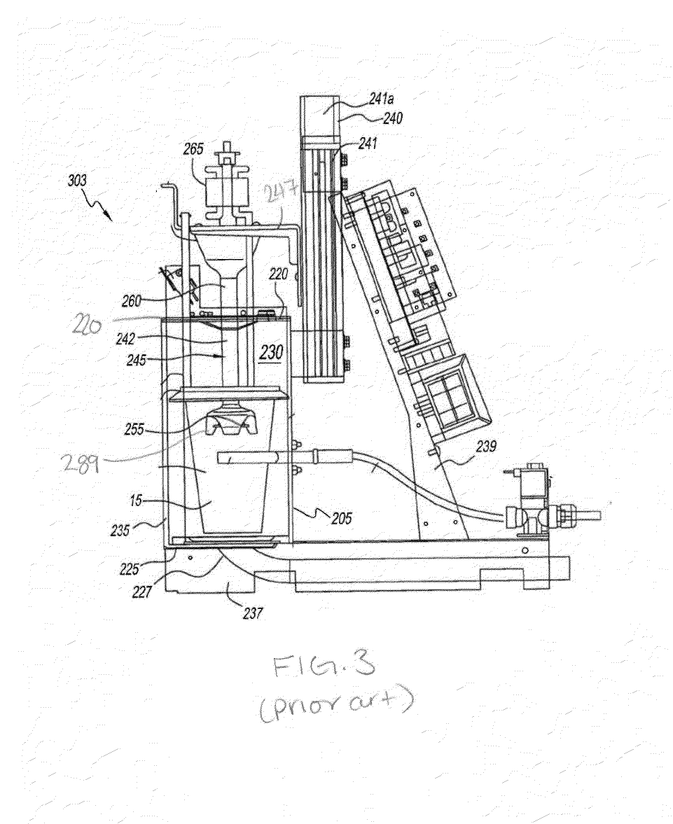

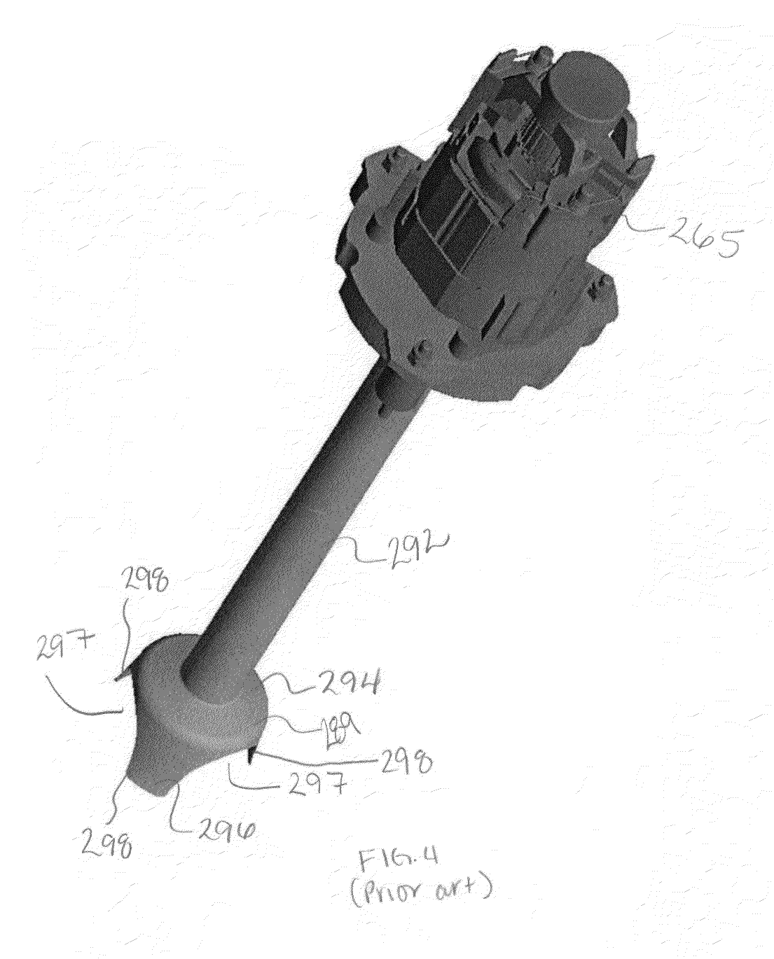

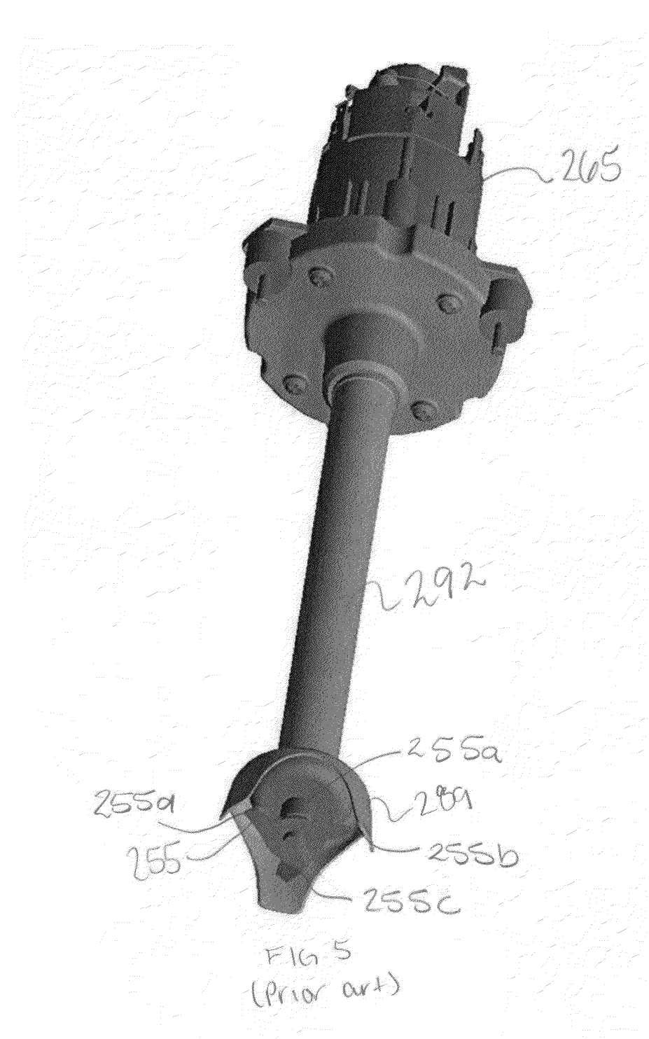

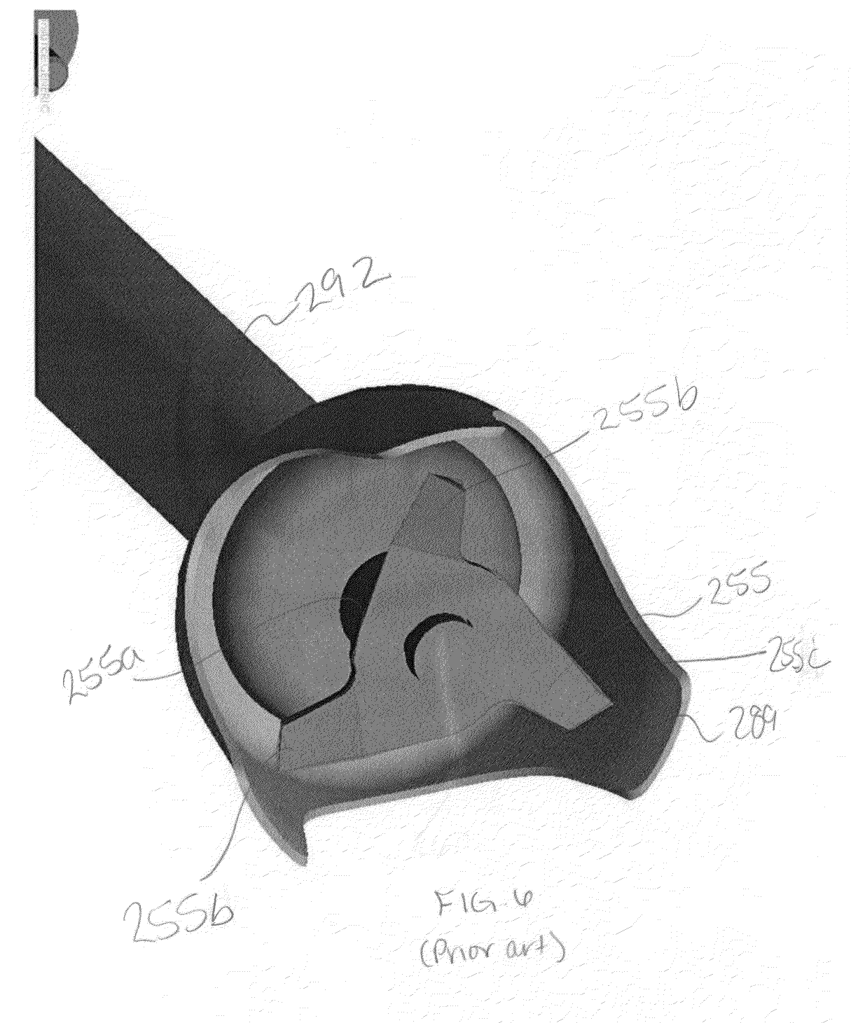

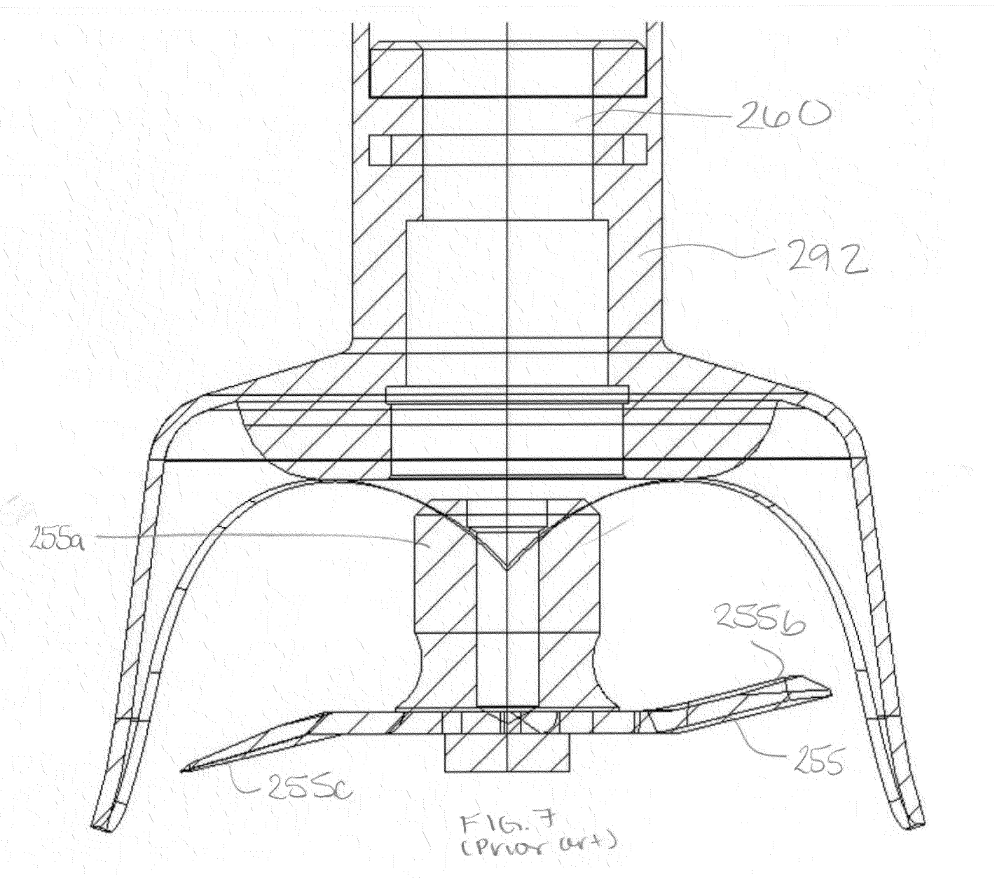

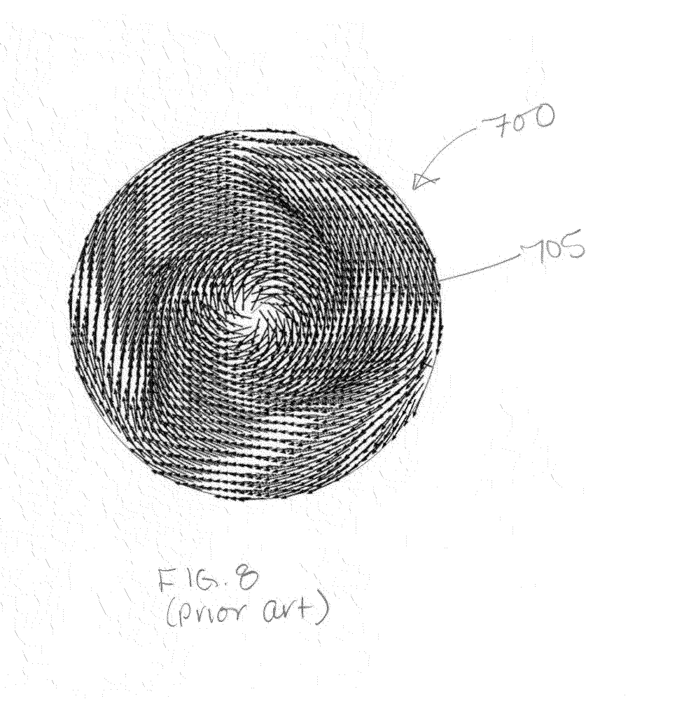

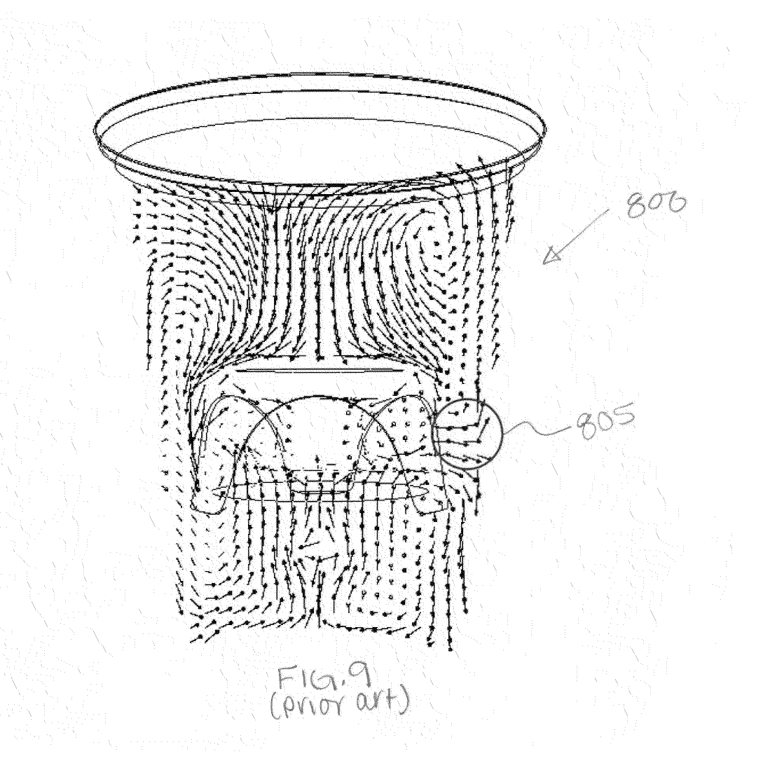

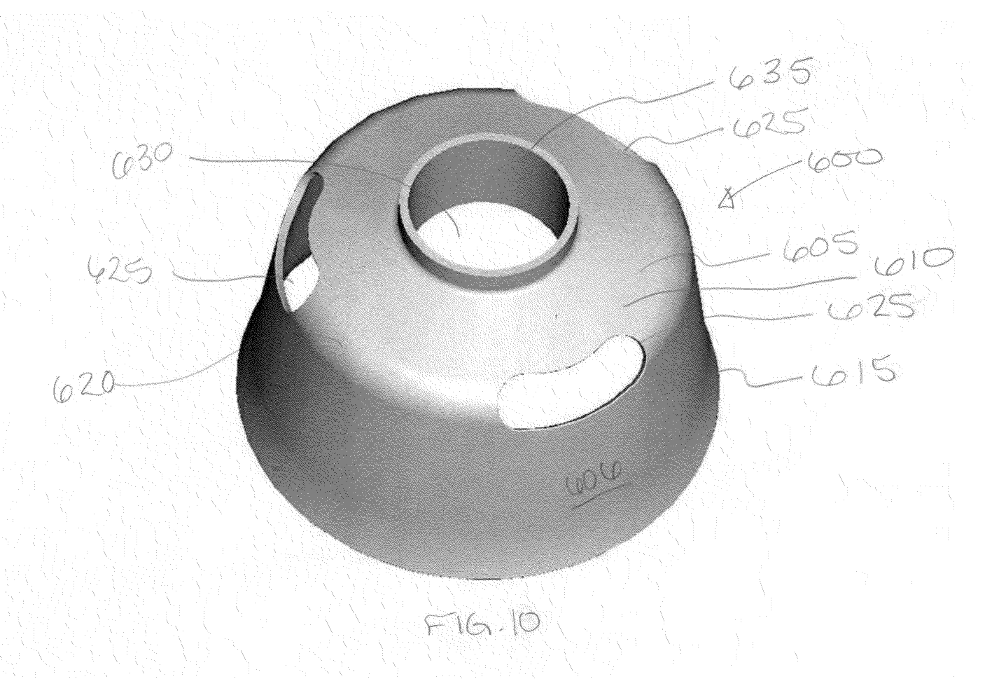

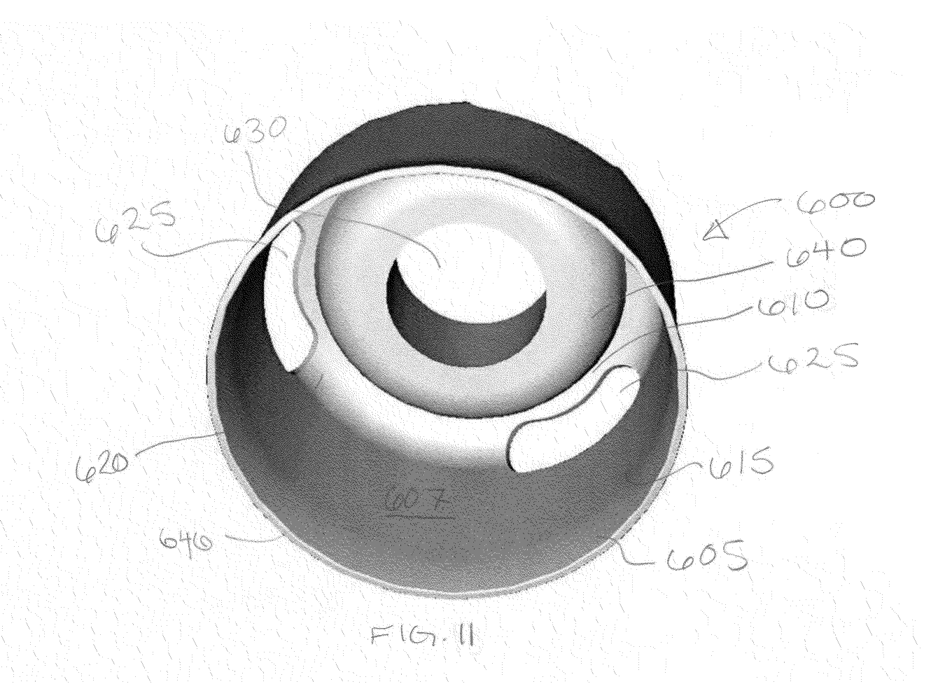

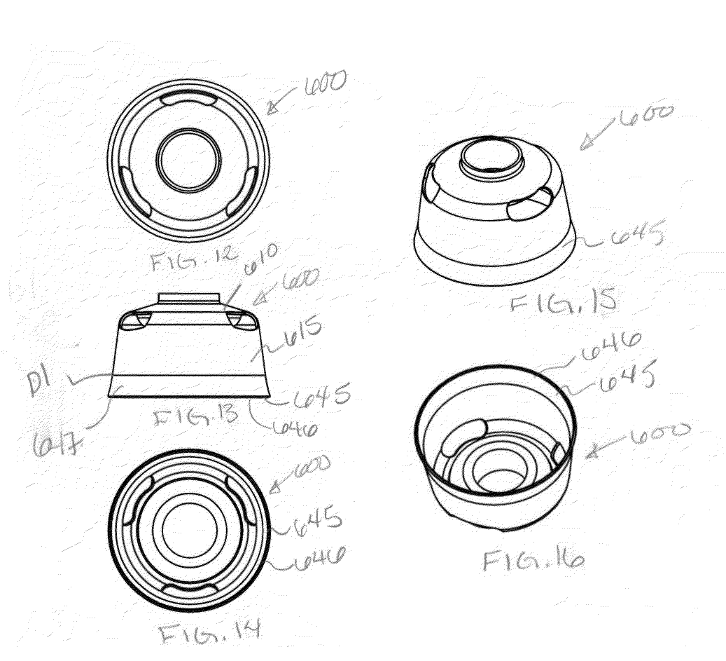

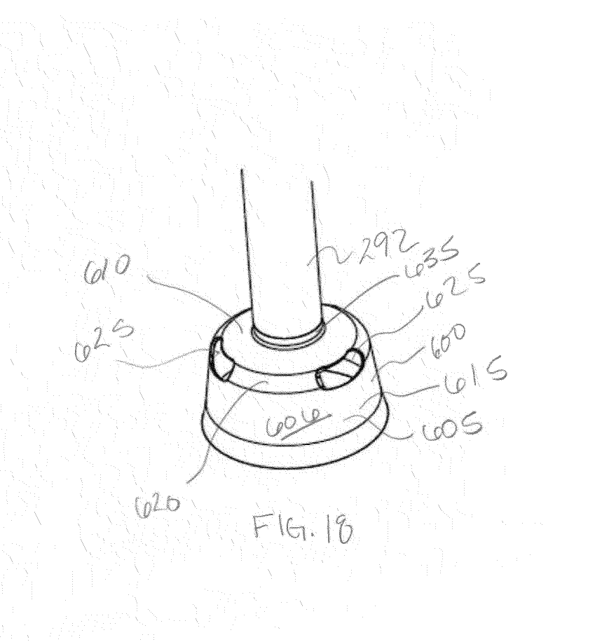

Referring to FIGS. 17 and 18, guard device 600 may be used with blender/mixer/cleaning modules 303 of FIGS. 1-3. However, guard device 600 may be used with any blender or mixer blade. Referring to FIG. 17, guard device 600 is connected to spindle shaft housing 292 of blender/mixer/cleaning modules 303. Guard device 600 is connected to spindle shaft housing 292 at connection wall 635.

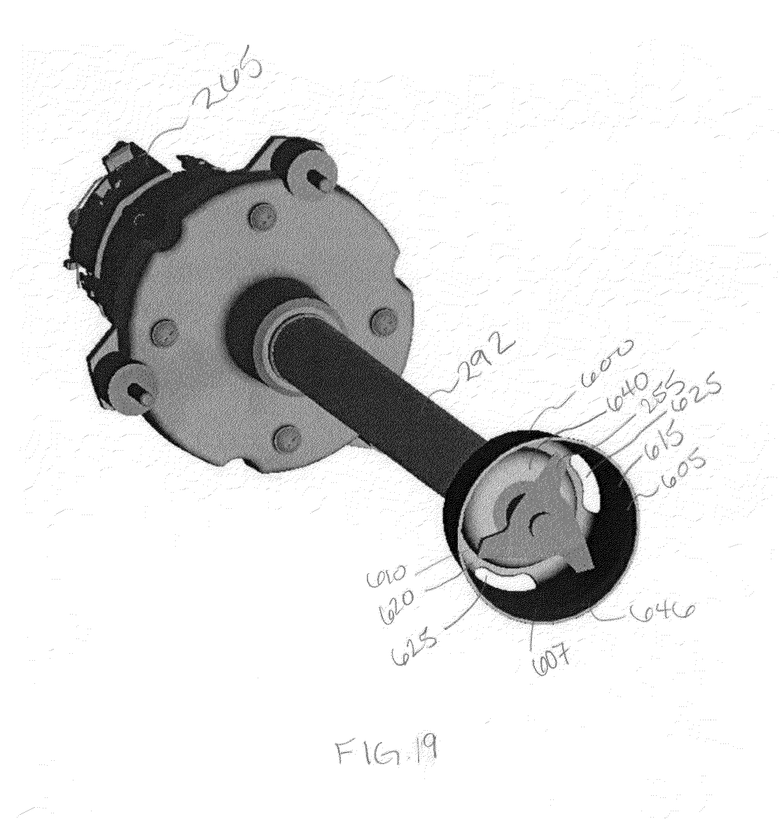

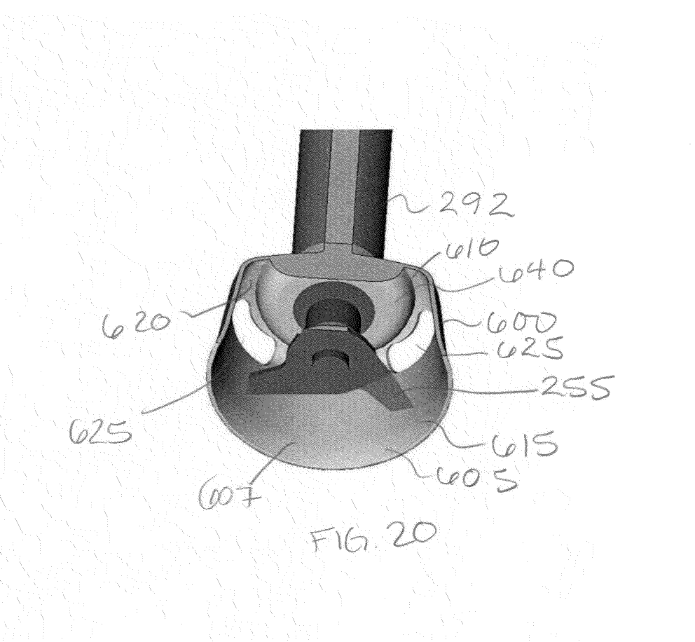

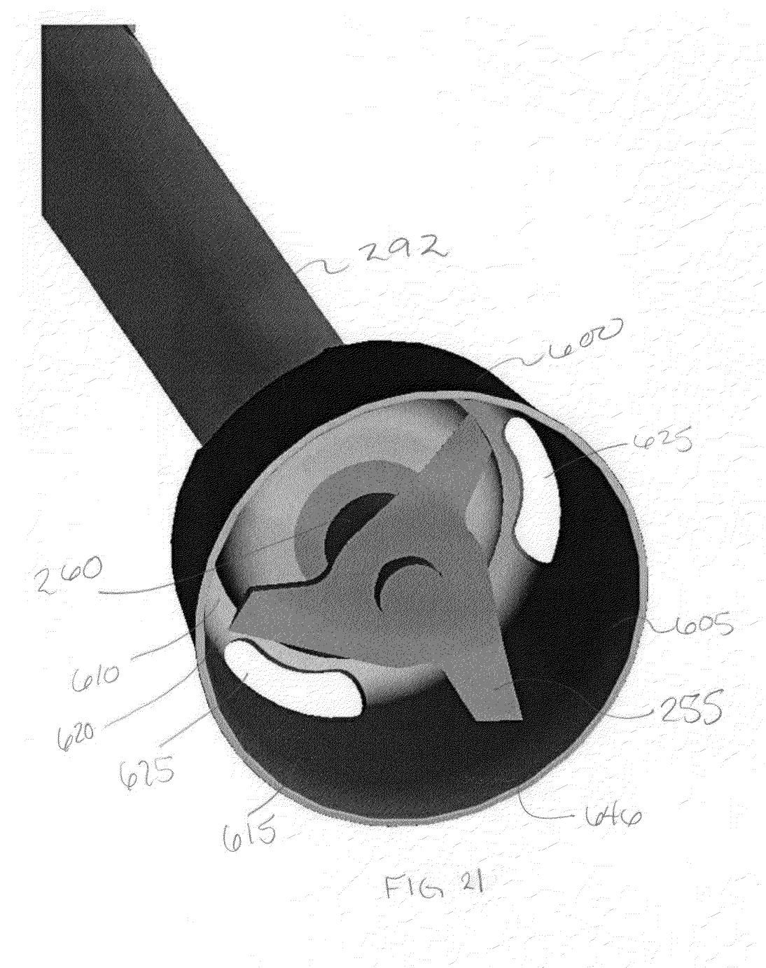

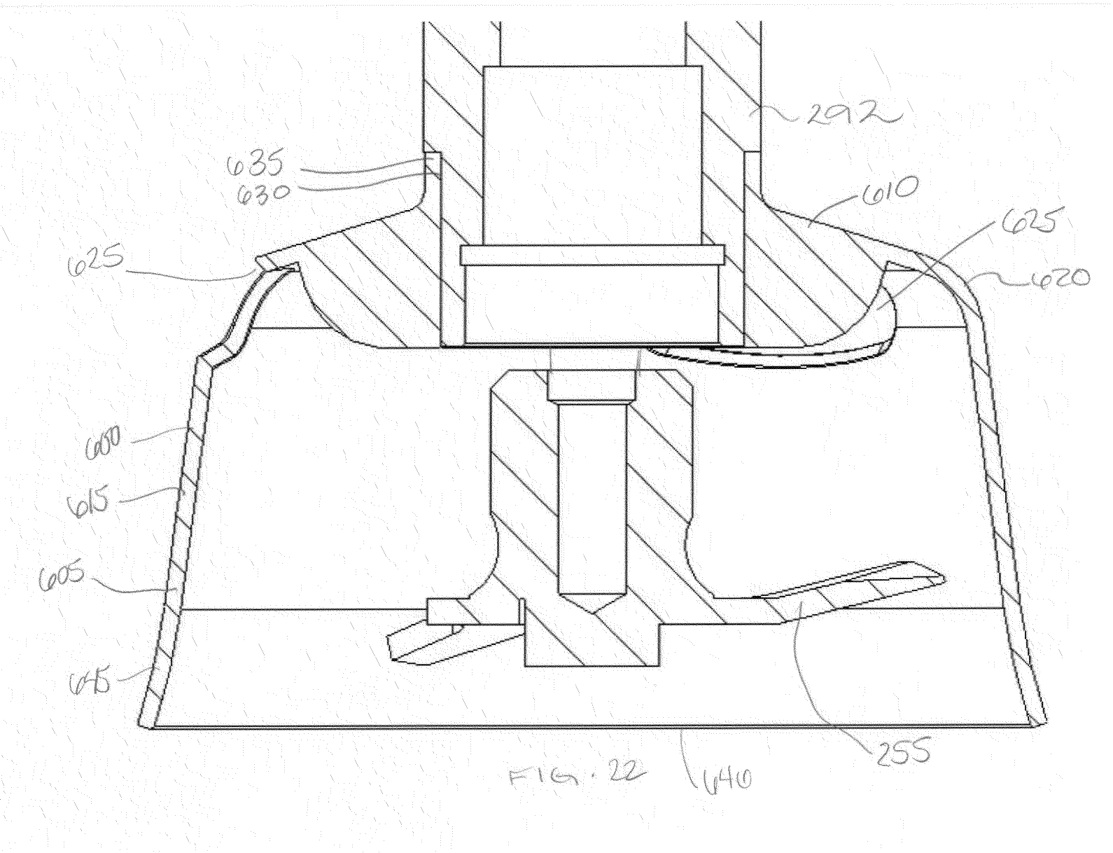

Referring to FIGS. 19-23, guard device 600 is connected to spindle shaft housing 292 so that blender blade 255 is surrounded by guard wall 605 and so that guard wall 605 extends beyond blender blade 255.

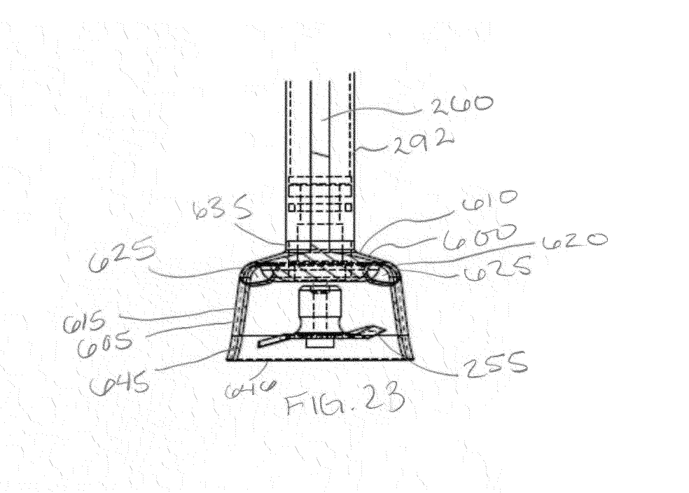

Referring to FIGS. 24-25, blender blade 255 is positioned in guard device 600 so that blade portions 255b, 255c and 255d overlap openings 625. Each of blade portions 255b, 255c and 255d has a leading edge 256 and a trailing edge 257. Leading edge 256 is on an opposite side of trailing edge 257 on each of blade portions 255b, 255c and 255d. Leading edge 256 is upstream of trailing edge 257 when blender blade 255 is rotated in a direction R.

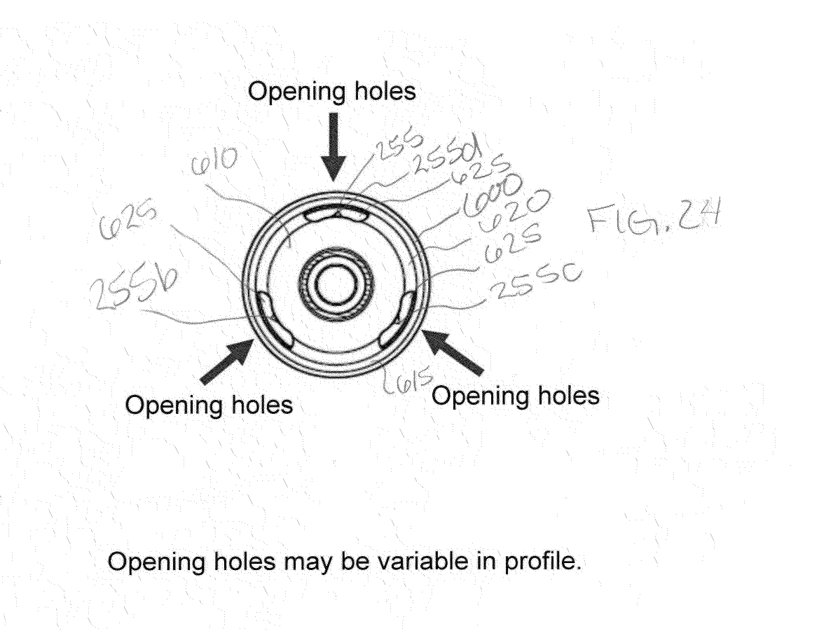

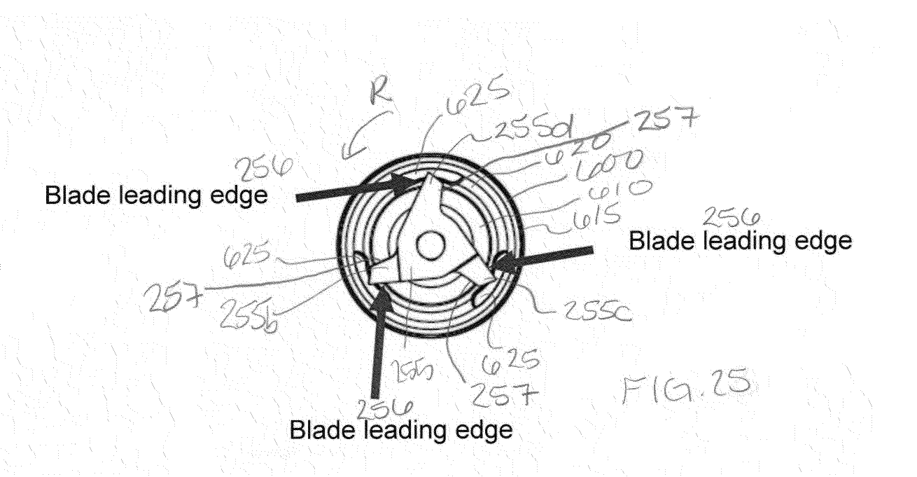

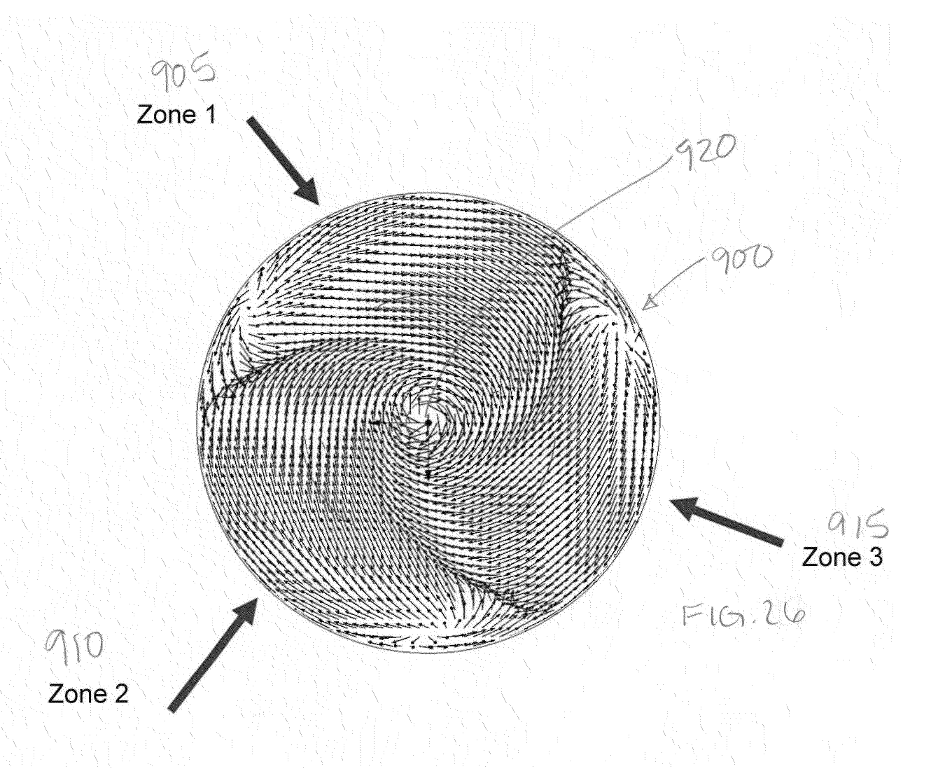

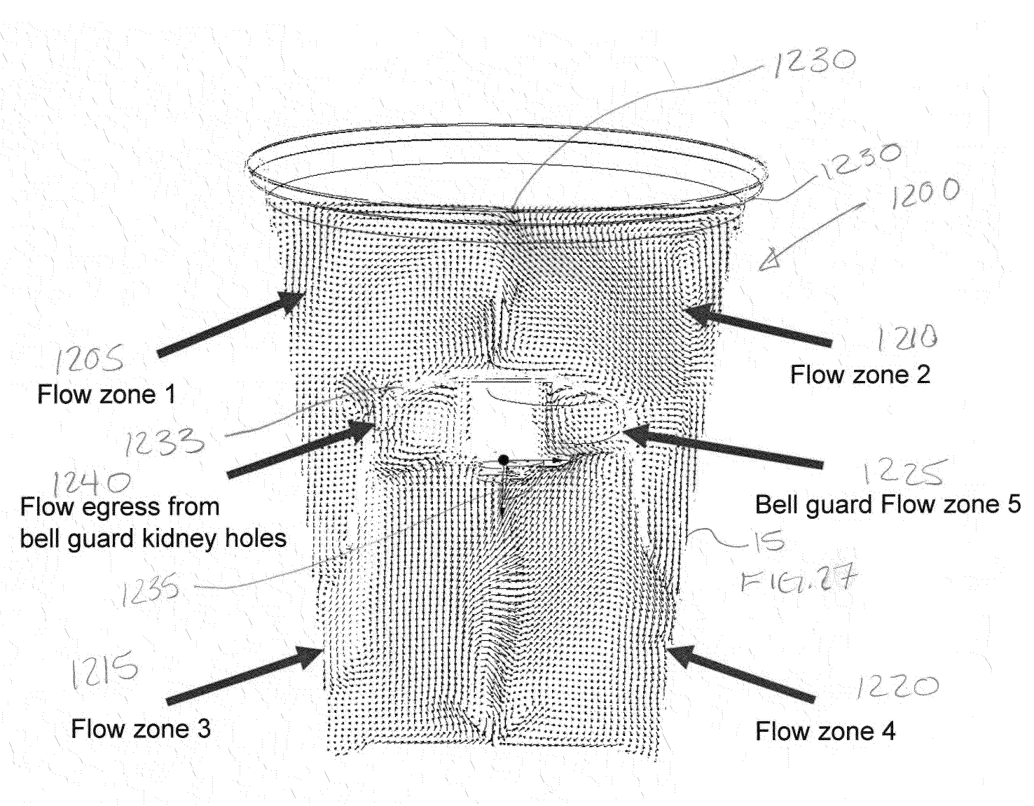

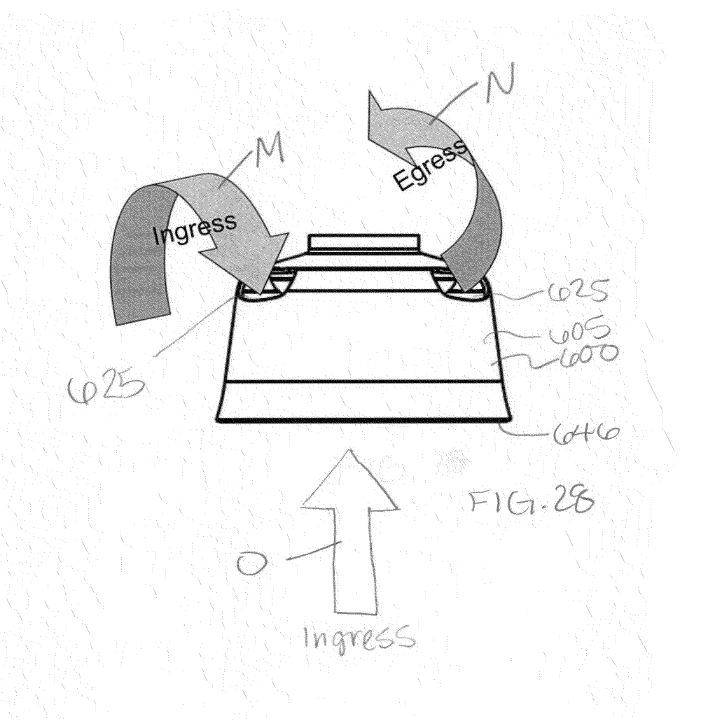

Referring to FIGS. 26-27, during operation of blender/mixer/cleaning modules 303, spindle shaft 260 rotates blender blade 255 in guard device 600 that generates two main flows of a fluid or a solid and fluid mixture in a container, for example, cup 15: a primary flow 900 as illustrated by arrows in FIG. 26, and secondary flows 1200 illustrated by arrows in FIG. 27. Primary flow 900 includes of three zones 905, 910 and 915. Each of zones 905, 910 and 915 has a swirl flow pattern that meets in a center 920. Secondary flows 1200 include of five zones 1205, 1210, 1215, 1220 and 1225 below a surface 1230, inside cup 15. A central vortex is formed down from a center 1230 and eddies perpendicular to the central vortex form in each of zones 1205, 1210, 1215 and 1220. A flow fountains up into guard device 600 that is located at a position 1233 that is symmetrical to the vertical axis 1235 of cup 15. A swirling flow forms in zone 1225 in guard device 600 which also has eddies perpendicular to vertical axis 1235.

Referring to FIG. 28, the present disclosure has found that position of openings 625 through guard wall 605 distinguishes guard device 600 from previous art, for example, blender blade or mixer blade guard device 289. Openings 625 change a flow of the fluid or the solid and fluid mixture as follows: as leading edge 256 of each of blade portions 255b, 255c and 255d passes under openings 625, the fluid or the solid and fluid mixture is drawn into guard device 600 through openings 625, as shown by arrow M, and, as trailing edge 257 of each of blade portions 255b, 255c and 255d passes under openings 625, the fluid or the solid and fluid mixture is drawn out through openings 625 out of guard device 600, as shown by arrow N and as shown by portion 1240 in FIG. 27, this sequence reoccurs with each passage of blade portions 255b, 255c and 255d. Referring to FIGS. 27 and 28, a majority of flow of the fluid or the solid and fluid mixture enters guard device 600 through bottom opening 646, as shown by the arrows in FIG. 27 and as shown by arrow O in FIG. 28, and exits out of guard device 600 through openings 625 generating a flow path of a majority of the mass flow rate. It has been found by the present disclosure that guard device 600 generates greater top to bottom circulation over the prior art, for example, blender blade or mixer blade guard device 289.

Guard device 600 eliminates high arching gaps 297 in blender blade or mixer blade guard device 289 therefore also eliminating excessive side forces on cup 15 that increases mixing time by forcing the fluid or the solid and fluid mixture to the bottom of the cup.

Guard device 600 shields the inside walls of any container that is used to hold solids and fluids to be mixed or blended, for example, cup 15, from direct impacts from any solids that are impacted or flowed by rotation of blender blade 255. Guard device 600 encloses blender blade 255 to reduce possible contact of blender blade 255 to a user of a blender or mixer that includes guard 600.

This allows fluid circulation through openings 625 of guard device 600 and reduces outward pressure over blender blade or mixer blade guard device 289. Fluid circulation through openings 625 of guard device 600 reduces a velocity of fluid and solid particles being blended or mixed that normally collide with the interior walls of cup 15, so that cracking of the wall of cup 15 is reduced or eliminated. Cup 15 is, for example, made of a polypropylene material.

Guard device 600 creates mixing and/or blending with a blender and/or mixing blade that reduces a time needed to mix and/or blend over use of blender blade or mixer blade guard device 289.

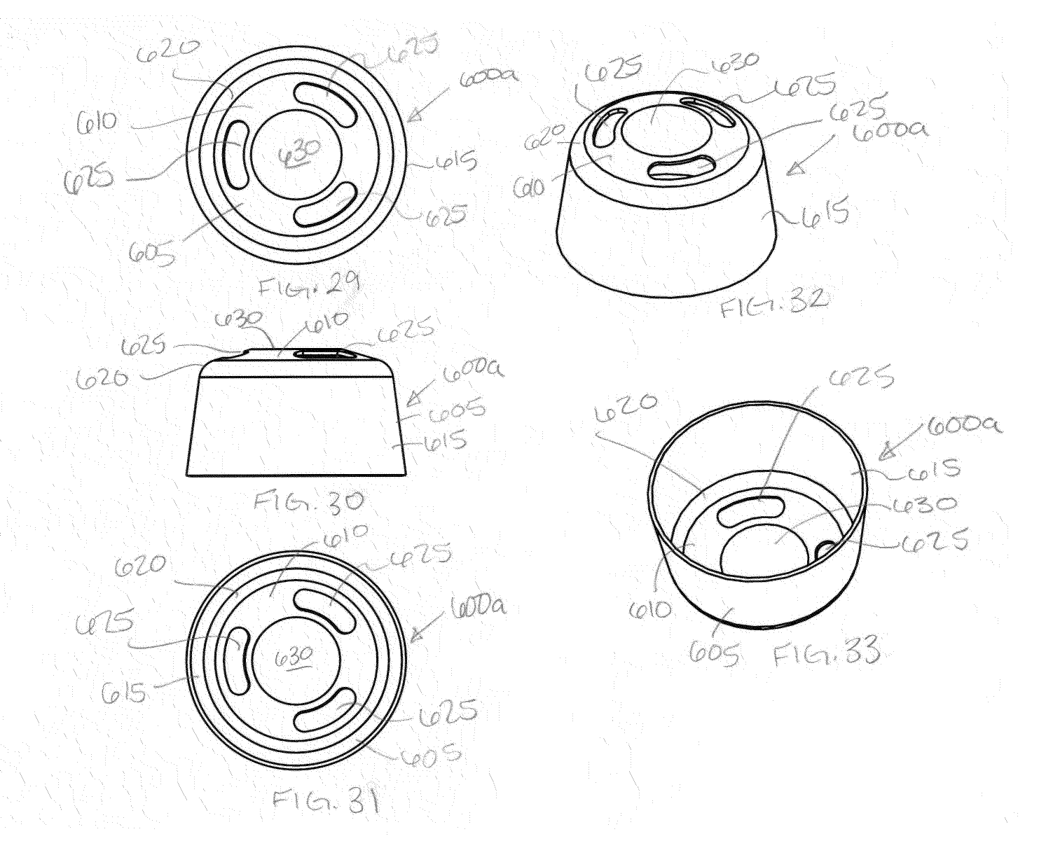

Referring to FIGS. 29-33, another embodiment of a blender blade or mixer blade guard device according to the present disclosure is shown and is generally referred to by reference numeral 600a (“guard device 600a”). Guard device 600a is similar to guard device 600, however, openings 625 are through top wall 610, sidewall 615 increases in size at a single rate from top wall 610 to end 645, and top wall 610 is not connected to connection wall 635 that surrounds connection aperture 630.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A blender blade or mixer blade guard device comprising:
a guard housing having a top portion and a sidewall; and
a plurality of openings disposed in said guard housing, each of said opening is located on said guard housing proximal to either said top portion, an interface between said top portion and said sidewall, said sidewall or any combinations thereof.

2. The blender blade or mixer blade guard device of claim 1, wherein said sidewall extends away from said top portion.

3. The blender blade or mixer blade guard device of claim 1, wherein said sidewall forms an angle of 65.55 degrees with said top portion.

4. The blender blade or mixer blade guard device of claim 1, wherein said top portion has a connection aperture.

5. The blender blade or mixer blade guard device of claim 1, wherein said plurality of openings are elongated oval or kidney bean shape.

6. The blender blade or mixer blade guard device of claim 4, wherein said top portion is connected to a connection wall that surrounds said connection aperture.

7. The blender blade or mixer blade guard device of claim 4, wherein said guard housing increases in thickness from a position on said top portion to said connection aperture forming a curved portion of an interior surface of said guard housing.

8. The blender blade or mixer blade guard device of claim 1, wherein said sidewall increases in size from said top portion to an end of said sidewall.

9. The blender blade or mixer blade guard device of claim 1, wherein said sidewall increases in size at a first rate from said top portion to a first distance and said sidewall increases in size at a second rate from said first distance to an end of said sidewall, and wherein said second rate is greater than the first rate.

10. The blender blade or mixer blade guard device of claim 1, wherein said guard housing is connected to a spindle shaft housing of a blender/mixer/cleaning module.

11. The blender blade or mixer blade guard device of claim 10, further comprising a blender blade that is surrounded by said guard housing so that said sidewall extends beyond blender blade.

12. The blender blade or mixer blade guard device of claim 11, wherein said blender blade has a center and a blade portion extending outward from said center, and wherein said blender blade is positioned in said guard housing so that said blade portion overlaps at least one of said plurality of openings.

13. A method of blending or mixing comprising:
rotating a blade in a blender blade or mixer blade guard device, said blender blade or mixer blade guard device directs flow of a fluid or a solid and fluid mixture through a plurality of openings, each of said plurality of openings being disposed in a guard housing of said blender blade or mixer blade guard device, each of said opening is located on said guard housing proximal to either a top portion of said guard housing, an interface between said top portion and said sidewall of said guard housing, said sidewall or any combinations thereof.

14. The method of claim 13, wherein said blender blade has a center and a blade portion extending outward from said center, and wherein said blade portion has a leading edge and a trailing edge so that as said leading edge passes under a first opening of said plurality of openings, said fluid or said solid and fluid mixture is drawn into said blender blade or mixer blade guard device through said first opening, and, as said trailing edge of said blade portion passes under said first opening, said fluid or said solid and fluid mixture is drawn out of said blender blade or mixer blade guard device through said first opening.

15. The method of claim 13, wherein said rotating generates a primary flow having three zones each with a swirl flow pattern that meets in a center.

16. The method of claim 13, wherein said rotating generates a plurality of secondary flows having a central vortex that is formed down from a center and eddies perpendicular to said central vortex, a flow that fountains up into said blender blade or mixer blade guard device that is located at a position that is symmetrical to a vertical axis of a container containing said fluid or said solid and fluid mixture, and a swirling flow forms in said blender blade or mixer blade guard device having eddies perpendicular to said vertical axis.

17. The method of claim 13, wherein said rotating generates a flow of said fluid or said solid and fluid mixture that enters blender blade or mixer blade guard device through a bottom opening and exits out of said blender blade or mixer blade guard device through said plurality of openings.

18. A blender blade or mixer blade guard device comprising:
a guard wall having a top wall and a sidewall connected to the top wall, the sidewall being connected to the top wall at an intersection; and
a plurality of openings being through said guard wall, each of said plurality of openings being at a position selected from the group consisting of through said top wall, through said top wall, said sidewall and said intersection of said top wall and said sidewall, through said sidewall and said intersection of said top wall and said sidewall, through said top wall and said intersection of said top wall and said sidewall, and any combinations thereof.
